(19) United States
(12) Patent Application Publication
(10) Pub. No.: US 2012/0182233 A1
(43) Pub. Date: Jul. 19, 2012

(54) TOUCH SCREEN PANEL

(76) Inventor: Jung-Yun Kim, Yongin-city (KR)

(21) Appl. No.: 13/208,268

(22) Filed: Aug. 11, 2011

(30) Foreign Application Priority Data
Jan. 18, 2011 (KR) 10-2011-0004975

(51) Int. Cl. G06F 3/041

(52) U.S. Cl. 345/173

(57) ABSTRACT

A touch screen panel including a substrate, a plurality of first sensing patterns including a plurality of first sensing cells arranged on one surface of the substrate in a first direction, and a plurality of first coupling patterns coupling the first sensing cells, a plurality of second sensing patterns including a plurality of second sensing cells arranged on one surface of the substrate in a second direction crossing the first direction, and a plurality of second coupling patterns coupling the second sensing cells, and a plurality of driving patterns between the second sensing patterns and the first sensing cells adjacent the second sensing patterns and coupled to the first sensing patterns.

### CROSS-REFERENCE TO RELATED APPLICATION

This application claims priority to and the benefit of Korean Patent Application No. 10-2011-0004975, filed on Jan. 18, 2011, in the Korean intellectual Property Office, the entire content of which is incorporated herein by reference.

### BACKGROUND

1. Field

An embodiment of the present invention relates to a touch screen panel.

2. Description of Related Art

A touch screen is an input device capable of selecting the indication content displayed on the screen of an image display device by a human hand or an object to input the command of a user.

The touch screen is provided on the front face of the image display device to convert a contact position of the human hand or the object into an electrical signal. Therefore, the instruction contact selected in the contact position is received as an input signal.

Since the touch screen may replace an additional input device coupled to the image display device, such as a keyboard and a mouse, the use range is gradually increasing.

Methods of operating a touch screen panel include a resistance layer method, a photo-sensing method, and an electrostatic capacity method.

FIG. 1 illustrates a conventional touch screen panel. The conventional touch screen panel utilizing an electrostatic capacity method will be described with reference to FIG. 1.

X sensing patterns 310 and Y sensing patterns 320 are arranged on a substrate 300 to cross each other.

The X sensing patterns 310 consist of sensing cells 311 arranged in an X-axis direction and coupling patterns 312 for coupling the sensing cells 311. The Y sensing patterns 320 consist of sensing cells 321 arranged in a Y-axis direction and coupling patterns 322 for coupling the sensing cells 321.

In an inactive region in an outline of (e.g., around) an active region where the sensing patterns 310 and 320 are arranged, first driving wiring lines 340 coupled to the

X sensing patterns 310 are positioned, and second driving wiring lines 350 coupled to the Y sensing patterns 320 are positioned. The driving wiring lines 340 and 350 are coupled to a pad unit 360.

However, as illustrated in FIG. 1, due to the first driving wiring lines 340 coupled to the X sensing patterns 310, a left dead space D1 and a right dead space D2 exist, so that it is difficult to reduce or minimize the size of the touch screen panel.

### SUMMARY

Accordingly, embodiments of the present invention provide a touch screen panel whose visibility is improved, and whose size is reduced or minimized by reducing a dead space in which driving wiring lines exist.

In addition, embodiments of the present invention provide a touch screen panel in which a metal layer is formed in a driving pattern to reduce the resistance of the driving pattern.

Embodiments of the present invention also provide a touch screen panel in which a dummy pattern is additionally formed, so that a resistance component is substantially uniform.

In order to achieve the foregoing and/or other aspects of the present invention, there is provided a touch screen panel including a substrate, a plurality of first sensing patterns including a plurality of first sensing cells arranged on one surface of the substrate in a first direction, and a plurality of first coupling patterns coupling the first sensing cells, a plurality of second sensing patterns including a plurality of second sensing cells arranged on one surface of the substrate in a second direction crossing the first direction, and a plurality of second coupling patterns coupling the second sensing cells, and a plurality of driving patterns between the second sensing patterns and the first sensing cells adjacent the second sensing patterns and coupled to the first sensing patterns.

The driving patterns may be coupled to the first sensing cells or the first coupling patterns.

The substrate may include an active region and an inactive region around the active region, the first sensing patterns and the second sensing patterns may be in the active region of the substrate, and the driving patterns may extend from the first sensing patterns to the inactive region of the substrate.

The touch screen panel may further include a plurality of first driving wiring lines in the inactive region of the substrate and coupled to the driving patterns, and a plurality of second driving wiring lines in the inactive region of the substrate and coupled to the second sensing patterns.

The driving patterns may include a transparent conductive material.

The touch screen panel may further include a metal layer on each of the driving patterns.

The touch screen panel may further include a plurality of dummy patterns separated from the driving patterns at intervals and between the second sensing patterns and the first sensing cells adjacent the second sensing patterns.

The dummy patterns may include metal.

The first coupling patterns and the second coupling patterns may cross each other with an insulating layer therebetween.

The first sensing cells and the second sensing cells may be in the same layer.

The first sensing patterns and the second sensing patterns may be in different layers.

As described above, according to embodiments of the present invention, it is possible to provide the touch screen panel whose visibility is improved and that is reduced or minimized by reducing the dead space in which driving wiring lines exist.

In addition, according to embodiments of the present invention, it is possible to provide the touch screen panel in which the metal layer is formed in the driving pattern to reduce the resistance of the driving pattern.

In addition, according to embodiments of the present invention, it is possible to provide the touch screen panel in which the dummy pattern is additionally formed so that the resistance component is more closely uniform.

### BRIEF DESCRIPTION OF THE DRAWINGS

The accompanying drawings, together with the specification, illustrate exemplary embodiments of the present invention, and, together with the description, serve to explain aspects of the present invention.

FIG. 1 is a view illustrating a conventional touch screen panel;

FIG. 2 is a view illustrating a substrate according to an embodiment of the present invention;

FIG. 3 is a view illustrating a touch screen panel according to a first embodiment of the present invention;

FIG. 4 is a cross-sectional view illustrating the section taken along the line A-B of FIG. 3;

FIG. 5 is a view illustrating a touch screen panel according to a second embodiment of the present invention;

FIG. 6 is a cross-sectional view illustrating the section taken along the line C-D of FIG. 5;

FIG. 7 is a view illustrating a touch screen panel according to a third embodiment of the present invention;

FIG. 8 is a cross-sectional view illustrating the section taken along the line E-F of FIG. 7; and

FIG. 9 is a view illustrating a touch screen panel according to a fourth embodiment of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on another element, or indirectly on another element with one or more intervening elements interposed therebetween. Also, when an element is referred to as being “connected” or “coupled to” another element, it can be directly coupled to another element, or indirectly coupled to another element with one or more intervening elements interposed therebetween. Hereinafter, like reference numerals refer to like elements.

Detailed items of other embodiments are included in detailed description and drawings.

Aspects and characteristics of the present invention and a method of achieving the aspects and characteristics of the present invention will be described more fully with reference to the accompanying drawings, in which exemplary embodiments of the invention are shown. This invention may, however, be embodied in many different forms, and should not be construed as being limited to the embodiments set forth herein. In the drawings, when a part is coupled to another part, the part may be directly coupled to another part, or the part may be electrically coupled to another part with another element interposed. In the drawings, some of the parts that are not related to the present invention may be omitted for clarity of description. The same reference numerals in different drawings represent the same elements, and thus, their description may be omitted.

Hereinafter, embodiments of the present invention will be described with reference to the accompanying drawings.

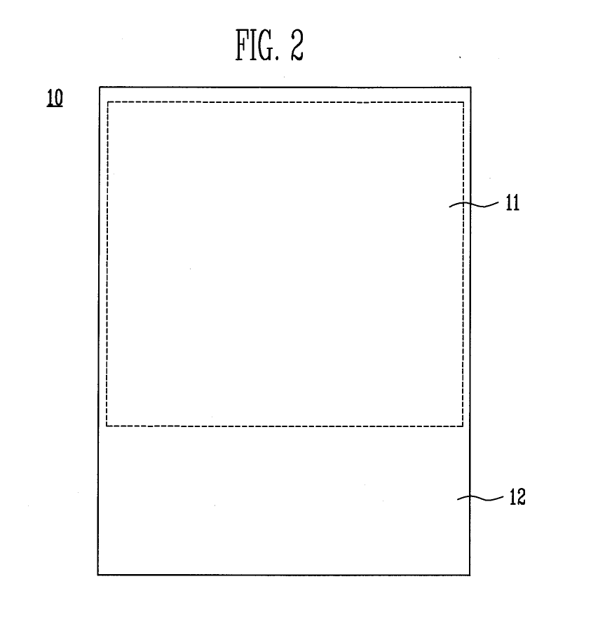

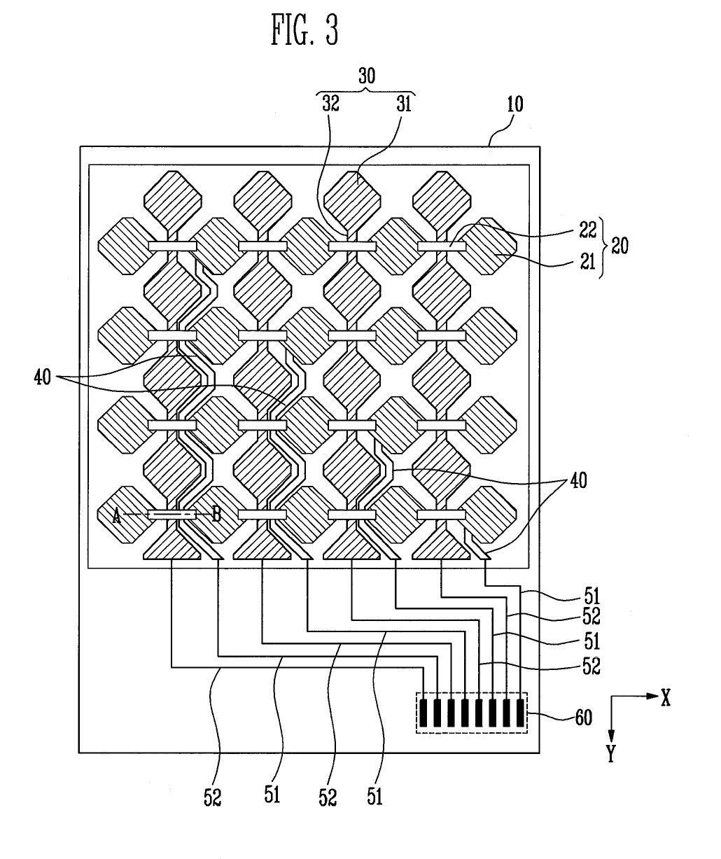

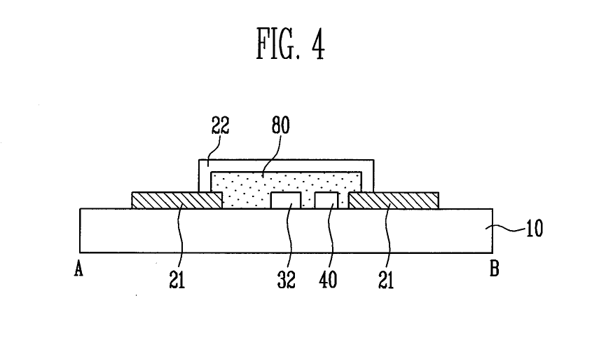

FIG. 2 is a view illustrating a substrate according to an embodiment of the present invention. FIG. 3 is a view illustrating a touch screen panel according to a first embodiment of the present invention. FIG. 4 is a cross-sectional view illustrating the section taken along the line A-B of FIG. 3.

The touch screen panel according to the first embodiment of the present invention includes a substrate 10, first sensing patterns 20, second sensing patterns 30, and driving patterns 40.

The substrate 10, as a transparent substrate on which the plurality of first sensing patterns 20, second sensing patterns 30, and driving patterns 40 are provided, may be formed of a material having insulation property such as glass, plastic, silicon, or synthetic resin, and may be formed of a flexible film.

In addition, as illustrated in FIG. 2, the substrate 10 includes an active region 11 in which the first sensing patterns 20, the second sensing patterns 30, and the driving patterns 40 are positioned, and an inactive region 12 defined by the region in the outline of the active region 11.

Driving wiring lines 51 and 52 and a pad unit 60 are positioned in the inactive region 12, and the edge of the inactive region 12 is used to be adhered to an upper substrate (not shown).

The first sensing patterns 20 are longitudinally formed in a first direction (for example, an X-axis direction) and are arranged in a second direction (for example, a Y-axis direction) that crosses the first direction.

The first sensing patterns 20 include a plurality of first sensing cells 21 arranged in the first direction at intervals (e.g., predetermined intervals) and a plurality of first coupling patterns 22 for electrically coupling the first sensing cells 21.

The second sensing patterns 30 are longitudinally formed in the second direction and are arranged in the first direction.

The second sensing patterns 30 include a plurality of second sensing cells 31 arranged in the second direction at intervals (e.g., predetermined intervals) and dispersed between the first sensing cells 21 to not overlap the first sensing cells 21, and a plurality of second coupling patterns 32 for electrically coupling the second sensing cells 31.

The first sensing cells 21 and the second sensing cells 31 may be formed of a transparent conductive material, such as indium tin oxide (ITO), carbon nano tube (CNT), and grapheme.

The first coupling patterns 22 and/or the second coupling patterns 32 may be formed of the transparent conductive material or a metal material.

In addition, the touch screen panel according to the first embodiment of the present invention may further include first driving wiring lines 51, second driving wiring lines 52, and a pad unit 60 to which the wiring lines 51 and 52 are coupled.

The first driving wiring lines 51 exist in the inactive region 12 and are electrically coupled to the first sensing patterns 20 through the driving patterns 40 that exist in the active region 11.

The second driving wiring lines 52 also exist in the inactive region 12 and are coupled to the second sensing patterns 30.

The first driving wiring lines 51 and the second driving wiring lines 52 may be formed of a low resistance material such as Mo, Ag, Ti, Cu, Al, Mo/Al/Mo, or a transparent conductive material.

The driving patterns 40 are longitudinally formed in the second direction and are positioned between the second sensing patterns 30 and the first sensing cells 21 adjacent to the second sensing patterns 30 to be electrically coupled to the first sensing patterns 20.

In addition, one end of each of the driving patterns 40 may be coupled to each of the first sensing cells 21 of the first sensing patterns 20, or may be coupled to each of the first coupling patterns 22 of the first sensing patterns 20. The other ends of the driving patterns 40 are coupled to the first driving wiring lines 51 positioned in the inactive region 12 under the driving patterns 40.

As illustrated in FIG. 3, the driving patterns 40 may be formed with curves in accordance with the shape of the spaces that exist between the second sensing cells 31 of the second sensing patterns 30 and the first sensing cells 21 adjacent to the second sensing cells 31. Therefore, since a difference in reflectance between parts in which the driving patterns 40 exist and the sensing patterns 20 and 30 is reduced, visibility is entirely improved.

The driving patterns 40 may be formed of the transparent conductive material like the first and second sensing cells 21 and 31 in order to transmit the image provided from below to above.

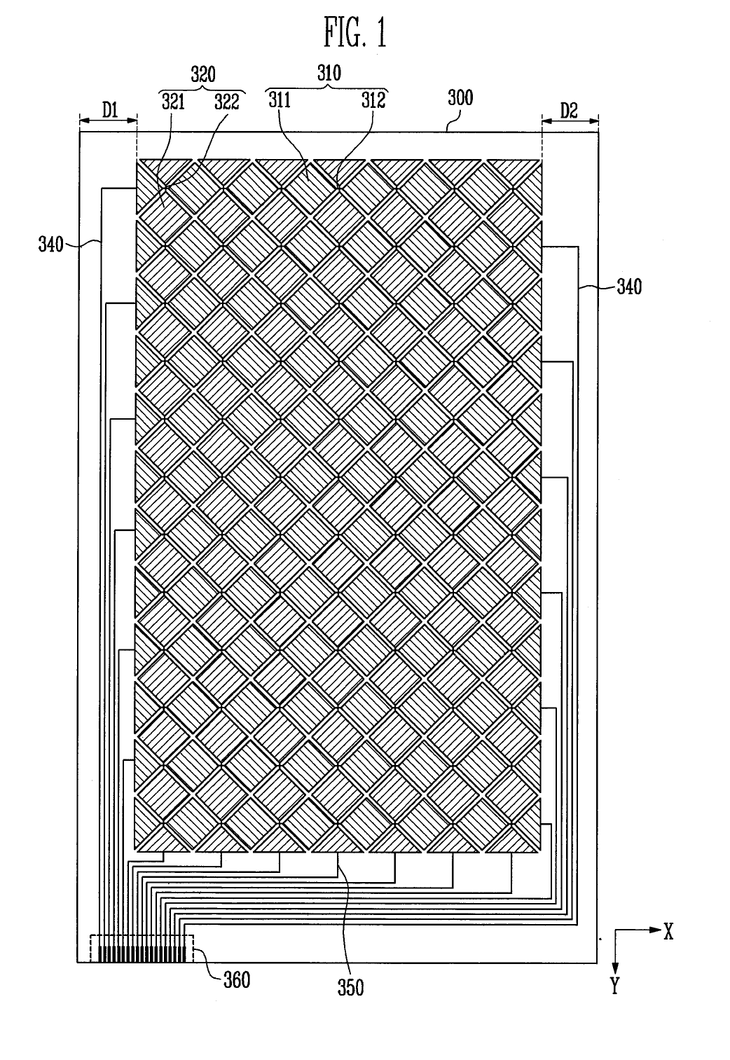

As a result, since the driving wiring lines 340 that exist in the left dead space D1 and the right dead space D2 of the conventional touch screen panel (e.g., see FIG. 1) may be replaced by the driving patterns 40 according to embodiments of the present invention, the conventional left dead space D1 and right dead space D2 may be removed so that it is possible to manufacture a touch screen panel of reduced or minimized size.

The first coupling patterns 22 and the second coupling patterns 32 may be arranged to cross each other, as illustrated in FIGS. 3 and 4. In this case, an insulating layer 80 may be interposed between the first coupling patterns 22 and the second coupling patterns 32 to insulate the first coupling patterns 22 and the second coupling patterns 32 from each other.

For example, as illustrated in FIG. 4, the first sensing cells 21, the second sensing cells 31, and the second coupling patterns 32 are formed in the same layer (for example, on the substrate 10) and the insulating layer 80 is formed on the second coupling patterns 32 so that the first coupling patterns 22 for electrically coupling the first sensing cells 21 separated from each other on both sides may be provided on the insulating layer 80.

In FIG. 4, for example, an embodiment, in which the insulating layer 80 is locally interposed only in the intersections of the first coupling patterns 22 and the second coupling patterns 32, is illustrated. However, when the insulating layer 80 is entirely formed in the active region 11 (e.g., see FIG. 2), an additional contact hole (not shown) is formed in the insulating layer 80, so that the first coupling patterns 22 couple the first sensing cells 21 through the contact hole.

In addition, in FIG. 4, the driving patterns 40 are positioned on the substrate 10. However, since the driving patterns 40 only have to be positioned in the active region 11 so that the first sensing patterns 20 are coupled to each other, the driving patterns 40 may exist on a layer other than the top surface of the substrate 10.

In addition, in FIG. 4, a one-layer structure, in which the first sensing cells 21 and the second sensing cells 31 are formed in the same layer (for example, on the substrate 10), is illustrated. However, the present invention may be applied to a structure (a two-layer structure) in which the first sensing patterns 20 and the second sensing patterns 30 are formed in different layers.

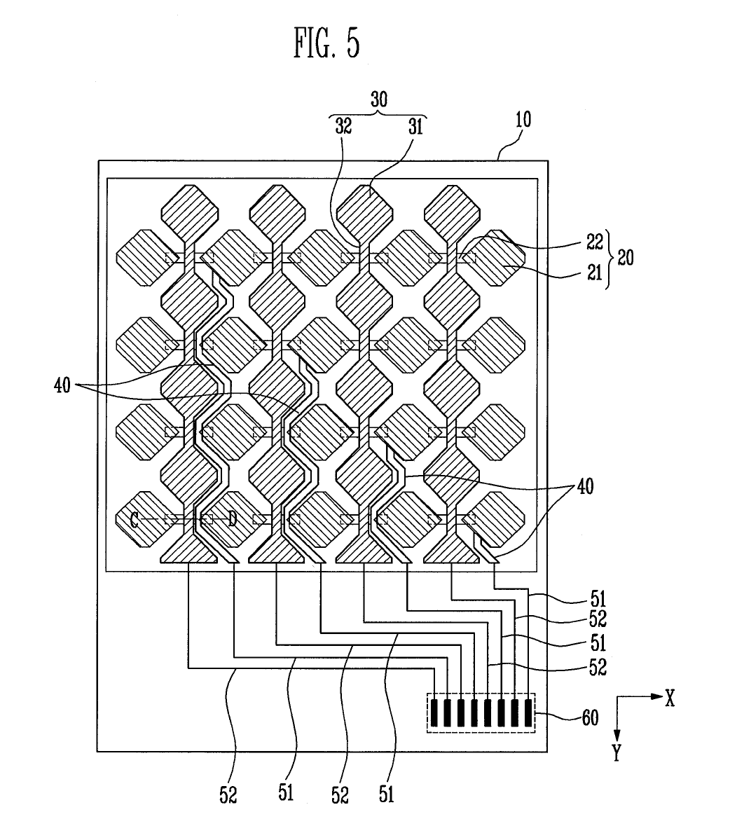

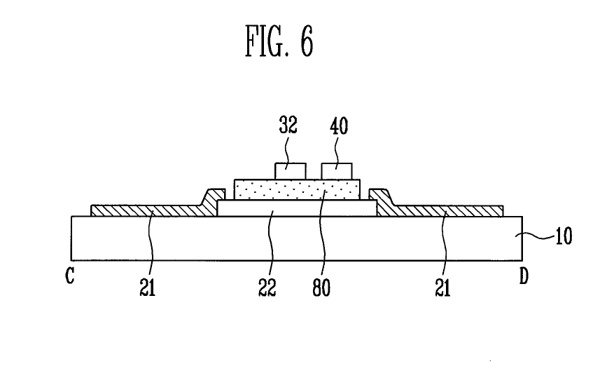

FIG. 5 is a view illustrating a touch screen panel according to a second embodiment of the present invention. FIG. 6 is a cross-sectional view illustrating the section taken along the line C-D of FIG. 5.

In the second embodiment, unlike the above-described first embodiment, the first coupling patterns 22 for coupling the first sensing cells 21 are positioned under the insulating layer 80.

Therefore, as illustrated in FIG. 6, the first sensing cells 21, the first coupling patterns 22, and the second sensing cells 31 may be formed on the same layer (for example, on the substrate 10), and the second coupling patterns 32 may couple the second sensing cells 31 while being electrically insulated from the first coupling patterns 22, with the insulating layer 80 may be interposed in the parts in which the first coupling patterns 22 intersect the second coupling patterns 32.

The driving patterns 40 are formed on the insulating layer 80 in the parts where the first coupling patterns 22 intersect the second coupling patterns 32, and are longitudinally formed in the second direction to be coupled to a specific first sensing pattern 20.

The insulating layer 80 may be locally formed in parts where the coupling patterns 22 and 32 intersect, as illustrated in FIG. 6, and may be entirely formed in the active region 11 (see FIG. 2).

When the insulating layer 80 is entirely formed, the second coupling patterns 32 may electrically couple the second sensing cells 31 through a contact hole (not shown) formed in the insulating layer 80, and the driving patterns 40 may be electrically coupled to specific first sensing patterns 20 through an additional contact hole (not shown) formed in the insulating layer 80.

Description of the same parts of the second embodiment as those of the first embodiment may be omitted.

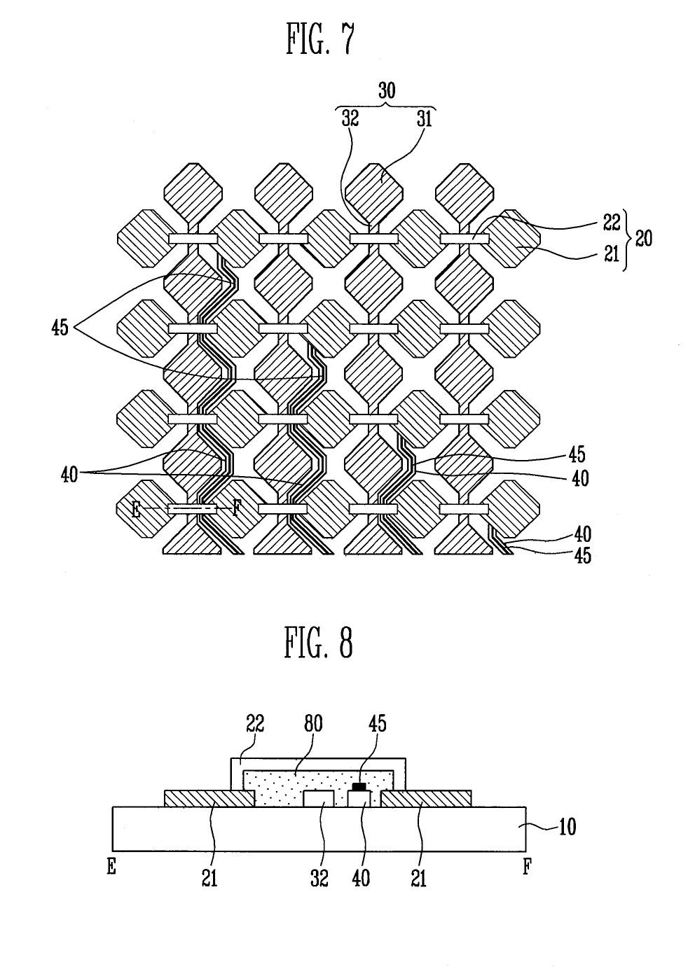

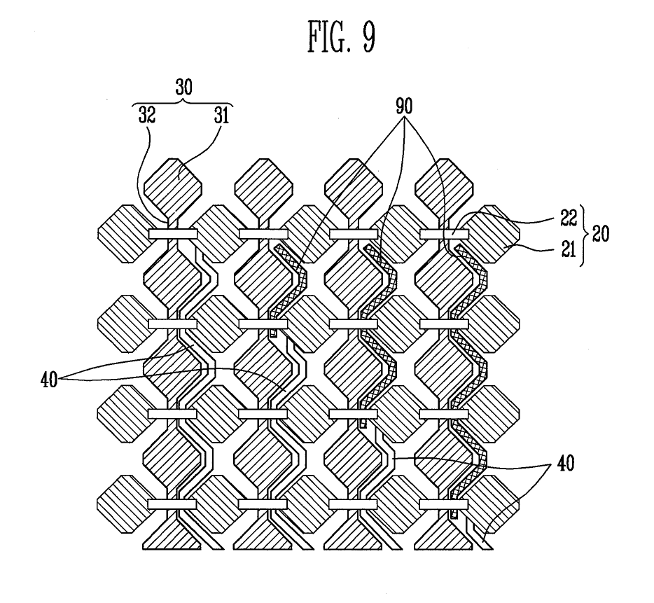

FIG. 7 is a view illustrating a touch screen panel according to a third embodiment of the present invention. FIG. 8 is a cross-sectional view illustrating the section taken along the line E-F of FIG. 7.

The touch screen panel according to the third embodiment of the present invention may further include a metal layer 45 formed on one side of each of the driving patterns 40.

When the driving patterns 40 that exist in the active region 11 are formed of the transparent conductive material, such as ITO, in order to reduce the resistance of the driving patterns 40, the metal layer 45 may be attached to a partial region or the entire region of one side of each of the driving patterns 40.

In FIGS. 7 and 8, the metal layer 45 is formed on the top surface of each of the driving patterns 40, or may be formed on the bottom surface of each of the driving patterns 40. In addition, at least one metal layer 45 may be formed in one driving pattern 40.

In addition, in FIGS. 7 and 8, the third embodiment is depicted as applied to the first embodiment. However, the third embodiment may also be applied to the second embodiment. Description of the same parts of the third embodiment as those of the above-described embodiments will be omitted.

FIG. 9 is a view illustrating a touch screen panel according to a fourth embodiment of the present invention.

The touch screen panel according to the fourth embodiment of the present invention further includes a plurality of dummy patterns 90.

Since the driving patterns 40 are coupled to the first sensing patterns 20, the lengths of the driving patterns 40 are different from each other. Therefore, since the magnitudes of the resistances that affect the sensing patterns 20 and 30 are different from each other, and a region in which the driving pattern 40 does not exist is generated, visibility deteriorates.

Therefore, additional dummy patterns 90 are provided above the driving patterns 40 so that the magnitudes of the resistances that affect the sensing patterns 20 and 30 are made to be more uniform, and visibility may be improved.

The dummy patterns 90 are separated from the corresponding driving patterns 40 positioned thereunder, and are longitudinally formed in the second direction between the second sensing patterns 30 and the first sensing cells 21 adjacent to the second sensing patterns 30. In addition, the dummy patterns 90, like the driving pattern 40, may be formed with curves in accordance with the shape of the spaces that exist between the second sensing cells 31 of the second sensing patterns 30 and the first sensing cells 21 adjacent to the second sensing cells 31.

In addition, although not shown in FIG. 9, the metal layers 45 described in the third embodiment may be formed in the driving patterns 40 of the fourth embodiment. Description of the same parts of the fourth embodiment as those of the above embodiments will be omitted.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A touch screen panel comprising:
a substrate;
a plurality of first sensing patterns comprising a plurality of first sensing cells arranged on one surface of the substrate in a first direction, and a plurality of first coupling patterns coupling the first sensing cells;
a plurality of second sensing patterns comprising a plurality of second sensing cells arranged on one surface of the substrate in a second direction crossing the first direction, and a plurality of second coupling patterns coupling the second sensing cells; and
a plurality of driving patterns between the second sensing patterns and the first sensing cells adjacent the second sensing patterns and coupled to the first sensing patterns.

2. The touch screen panel as claimed in claim 1, wherein the driving patterns are coupled to the first sensing cells or the first coupling patterns.

3. The touch screen panel as claimed in claim 1,
wherein the substrate comprises an active region and an inactive region around the active region,
wherein the first sensing patterns and the second sensing patterns are in the active region of the substrate, and
wherein the driving patterns extend from the first sensing patterns to the inactive region of the substrate.

4. The touch screen panel as claimed in claim 3, further comprising:
a plurality of first driving wiring lines in the inactive region of the substrate and coupled to the driving patterns; and
a plurality of second driving wiring lines in the inactive region of the substrate and coupled to the second sensing patterns.

5. The touch screen panel as claimed in claim 1, wherein the driving patterns comprise a transparent conductive material.

6. The touch screen panel as claimed in claim 5, further comprising a metal layer on each of the driving patterns.

7. The touch screen panel as claimed in claim 1, further comprising a plurality of dummy patterns separated from the driving patterns at intervals and between the second sensing patterns and the first sensing cells adjacent the second sensing patterns.

8. The touch screen panel as claimed in claim 7, wherein the dummy patterns comprise metal.

9. The touch screen panel as claimed in claim 1, wherein the first coupling patterns and the second coupling patterns cross each other with an insulating layer therebetween.

10. The touch screen panel as claimed in claim 1, wherein the first sensing cells and the second sensing cells are in the same layer.

11. The touch screen panel as claimed in claim 1, wherein the first sensing patterns and the second sensing patterns are in different layers.
